(19) United States
(12) Patent Application Publication
(10) Pub. No.: US 2022/0227313 A1
(43) Pub. Date: Jul. 21, 2022

(54) VEHICULAR CEILING MATERIAL AND METHOD FOR MANUFACTURING SAME

(71) Applicant: KASAI KOGYO CO., LTD., Kanagawa (JP)

(72) Inventor: Hiroki NOMURA, Hiratsuka-shi, Kanagawa (JP)

(21) Appl. No.: 17/620,382

(22) PCT Filed: Jun. 28, 2019
(86) PCT No.: PCT/JP2019/025809

§ 371 Date: Dec. 17, 2021

(51) Int. Cl. B60R 13/02; B32B 7/12; B32B 3/08

(52) U.S. Cl. CPC B60R 13/0218; B32B 7/12; B32B 3/08; B32B 2255/10; B32B 2250/03; B32B 2255/205; B32B 2605/003

(57) ABSTRACT

A vehicle ceiling material includes: a base material; a skin layer provided on a vehicle-interior side of the base material and forming a ceiling surface in a vehicle interior; a back surface layer as a film layer provided on a back-surface side of the base material; a first adhesive layer between the base material and the skin layer; and a second adhesive layer between the base material and the back surface layer. The vehicle ceiling material includes a fiber body layer formed of a fiber and provided, between the back surface layer and the second adhesive layer, partially to the back surface layer. A part in the back surface layer and over the fiber body layer is cut out.

### CROSS-REFERENCE TO RELATED APPLICATIONS

This application is a National Stage Entry application of PCT International Application No. PCT/JP2019/025809, filed on Jun. 28, 2019, the entire contents of which are hereby incorporated by reference.

### BACKGROUND

### 1. Technical Field

The present invention relates to a vehicle ceiling material and a method for manufacturing the same.

### 2. Description of the Background

A conventionally known vehicle ceiling material includes at least a base material, a skin layer, and a back surface layer, and is provided at a roof portion of a vehicle. A bracket is attached on the back surface layer. The vehicle ceiling material is attached to a vehicle ceiling panel via the bracket. Some of such vehicle ceiling materials each include, as the back surface layer, a fiber body such as a nonwoven fabric. Others proposed as the vehicle ceiling material each include, as the back surface layer, a film layer (e.g., a metal vapor-deposited film) as in the case of a heat-shielding ceiling for example (refer to Japanese Patent Application Laid-open Publication No. 2013-47070 herein after referred to as “Patent Literature 1”, for example).

### BRIEF SUMMARY

However, since the vehicle ceiling material described in Patent Literature 1 includes the film layer as the back surface layer, it becomes difficult to attach the bracket to the back surface layer as compared with the case where the fiber body is used as the back surface layer. For this reason, a reactive hot-melt adhesive is used, and the bracket is made of an acrylonitrile butadiene styrene (ABS) resin, in order to attach the bracket to the back surface layer. However, the reactive hot-melt adhesive takes a lot of time and work in terms of management and is disadvantageous in terms of cost, as compared with an olefin-based hot-melt adhesive. The ABS resin is also disadvantageous in terms of cost as compared with polypropylene (PP).

The present invention has been made in view of such a circumstance. An object of the present invention is to provide a vehicle ceiling material advantageous in terms of cost and enabling a bracket to be attached satisfactorily to the vehicle ceiling material without necessity of using a hot-melt adhesive that takes a great deal of time and work in terms of management, when the vehicle ceiling material includes a film layer as a back surface layer. An object of the present invention is also to provide a method for manufacturing the same vehicle ceiling material.

In order to solve the problem, a first invention is a vehicle ceiling material including a base material, a skin layer, a back surface layer that is a film layer, a first adhesive layer, and a second adhesive layer. The vehicle ceiling material includes a fiber body layer that is formed of a fiber and that is provided, between the back surface layer and the second adhesive layer, partially to the back surface layer. A part included in the back surface layer and positioned over the fiber body layer is cut out.

In order to solve the problem, a second invention includes a first step of layering a skin layer, a first adhesive layer, a base material, a second adhesive layer, and a back surface layer in this order, and integrating the skin layer, the first adhesive layer, the base material, the second adhesive layer, and the back surface layer with each other while interposing a fiber body layer between the back surface layer and the second adhesive layer. The back surface layer is a film layer. The fiber body layer is formed of a fiber, and is provided partially to the back surface layer. The second invention includes a second step of cutting out, by an area equal to or smaller than the fiber body layer, a part included in the back surface layer in an integrated body that is integrated at the first step. The cut-out part is positioned over the fiber body layer.

According to the present invention, an advantage is obtained in terms of cost, and a bracket can be satisfactorily attached without necessity of using a hot-melt adhesive that takes a great deal of time and work in terms of management.

### BRIEF DESCRIPTION OF DRAWINGS

FIG. 1 is a sectional view illustrating a vehicle ceiling material according to the present embodiment.

FIG. 2 is a perspective view of the vehicle ceiling material illustrated in FIG. 1, and illustrates a state perspectively viewed from a side of a back surface layer.

FIG. 3A is a step diagram of a method for manufacturing the vehicle ceiling material according to the present embodiment, and illustrates a layering step.

FIG. 3B is a step diagram of the method for manufacturing the vehicle ceiling material according to the present embodiment, and illustrates a hot pressing step.

FIG. 3C is a step diagram of the method for manufacturing the vehicle ceiling material according to the present embodiment, and illustrates a cutting-out step.

### DETAILED DESCRIPTION

The following describes the present invention with reference to a preferred embodiment. The present invention is not limited to the embodiment described below, and can be appropriately modified within the scope not departing from the essence of the present invention. Some parts of a configuration are omitted from the illustrations and the description in the embodiment described below. Needless to say, publicly known or well-known techniques are, however, appropriately applied for details of the omitted techniques, within a range not contradicting with the contents described below.

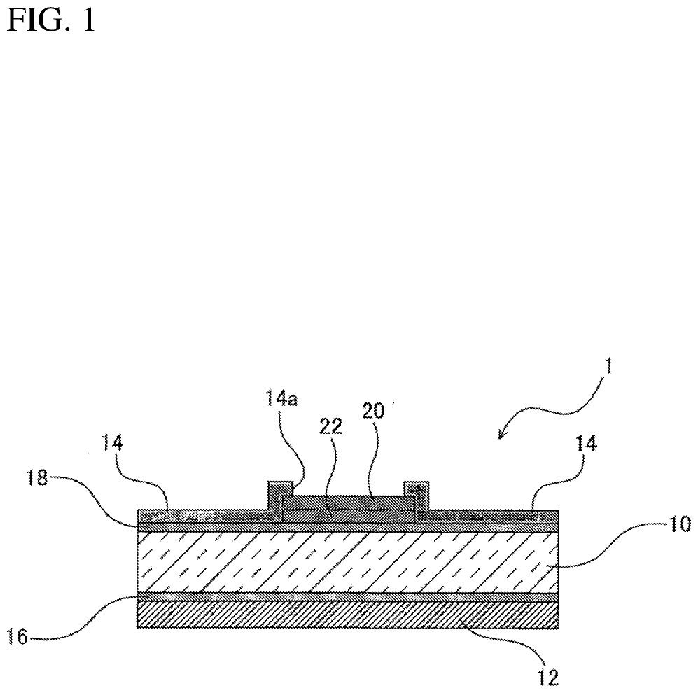

FIG. 1 is a sectional view illustrating a vehicle ceiling material according to the present embodiment. The vehicle ceiling material 1 according to the present embodiment is provided at a roof portion of a vehicle. The vehicle ceiling material 1 is attached on a vehicle interior side of a vehicle ceiling panel. The vehicle ceiling material 1 includes a base material 10, a skin layer 12, a back surface layer 14, a first adhesive layer 16, and a second adhesive layer 18.

The base material 10 is made of a foam material such as semi-rigid urethane foam. The skin layer 12 is provided on a vehicle-interior side of the base material 10, and forms a ceiling surface in the vehicle interior. The back surface layer 14 is a film layer provided on a back-surface side (on a vehicle ceiling-panel side) of the base material 10. The back surface layer 14 is constituted by a metal vapor-deposited film. The metal vapor-deposited film includes a resin film made of polyethylene terephthalate (PET) or the like, and includes metal, such as aluminum, vapor-deposited on the resin film. The back surface layer 14 may include the metal vapor-deposited film and an inorganic (e.g., silica-based) antioxidation coat provided on the metal vapor-deposited film. The antioxidation coat suppresses oxidation of the metal such as aluminum. The back surface layer 14 is arranged such that the resin film or the antioxidation coat is on a ceiling-panel side.

The first adhesive layer 16 is provided between the base material 10 and the skin layer 12, and has an adhesion function for adhering these to each other. The second adhesive layer 18 is provided between the base material 10 and the back surface layer 14, and has an adhesion function for adhering these to each other. Such first and second adhesive layers 16 and 18 are made of glass fibers coated or impregnated with isocyanate. At the time of the adhering, water containing amine diluted with it is applied to the adhering-target surfaces by spraying or the like. Thereby, the first and second adhesive layers 16 and 18 react with the isocyanate, causing generation of urea so that the adhesion occurs.

Here, a bracket is attached, on a side of the back surface layer 14, to such a vehicle ceiling material 1 via a hot-melt adhesive or the like. The bracket is connected to the ceiling panel. Thereby, the vehicle ceiling material 1 is attached to the ceiling panel.

However, the attaching of the bracket is difficult for the vehicle ceiling material 1 including the film layer as the back surface layer 14, compared with that for a vehicle ceiling material including a fiber body as a back surface layer.

Specifically, the fiber body in the vehicle ceiling material including the fiber body as the back surface layer can absorb a dimensional change even when the hot-melt adhesive changes in dimension due to an environmental change after its adhesion. Accordingly, unbearable stress is unlikely to be generated. Thus, an olefin-based hot-melt adhesive suffices as the hot-melt adhesive, and accordingly, the bracket can be made of PP that is advantageous in terms of cost.

Meanwhile, when the film layer having been subjected to metal vapor-deposition or the like as in the case of a heat-shielding ceiling is provided as the back surface layer 14, the film layer cannot absorb the dimensional change as the fiber body does. Accordingly, unbearable stress is likely to be generated so that interface peeling occurs between the hot-melt adhesive and the film layer (back surface layer 14). For this reason, a reactive hot-melt adhesive having greater adhesion strength is unavoidably used, and accordingly, the bracket is made of an ABS resin suitable for the reactive hot-melt adhesive.

Here, the reactive hot-melt adhesive cures by humidity in the air. For this reason, the reactive hot-melt adhesive in an application device that applies the reactive hot-melt adhesive is washed away when its use is ended, so as to avoid a situation where the reactive hot-melt adhesive cures in a non-used time and thereby hinders subsequent use. Further, the reactive hot-melt adhesive has great adhesion strength at the time of curing, but takes a long time to cure. Accordingly, the bracket and the reactive hot-melt adhesive are kept contacting with each other during the time up to the curing. Thus, at an additional step, for example, a tape is attached to the bracket so as to keep the bracket contacting with the reactive hot-melt adhesive. Furthermore, the reactive hot-melt adhesive cannot be stored for a long period of time because of curing by humidity in the air, and is thus discarded at regular intervals.

In view of it, the vehicle ceiling material 1 according to the present embodiment includes a fiber body layer 20 between the back surface layer 14 and the second adhesive layer 18. The fiber body layer 20 is a member formed of a fiber such as a spun-laced or spun-bonded nonwoven fabric or a woven fabric. The fiber body layer 20 is provided partially to the back surface layer 14. In addition, a part included in the back surface layer 14 and positioned over the fiber body layer 20 is cut out (by an area equal to or smaller than the fiber body layer 20). Thus, the vehicle ceiling material 1 according to the present embodiment is structured such that while the back surface layer 14 is constituted by the film layer, the part of the back surface layer 14 is cut out so as to expose the fiber body layer 20.

A second film layer 22 having a ventilation blocking function is further provided between the fiber body layer 20 and the second adhesive layer 18. The second film layer 22 is provided so as to correspond to the part (cut-out opening 14a) cut out in the back surface layer 14.

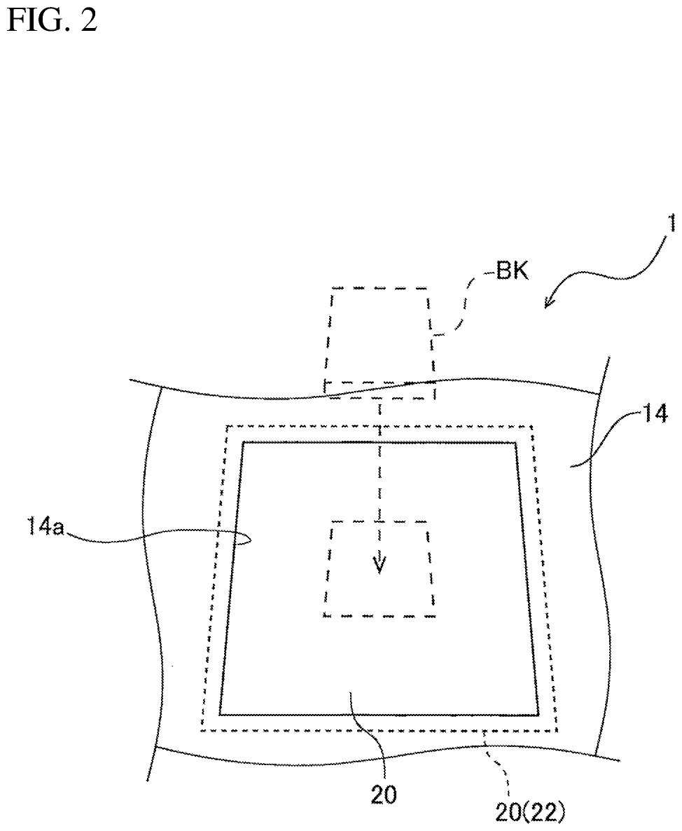

FIG. 2 is a perspective view of the vehicle ceiling material 1 illustrated in FIG. 1, and illustrates a state perspectively viewed from a side of the back surface layer 14. The part that is included in the back surface layer 14 and that is at a set position (refer to the broken line) on the fiber body layer 20 is cut out by an area smaller than the fiber body layer 20 so that the cut-out opening 14a is formed, as illustrated in FIG. 2. As a result, only the fiber boy layer 20 is exposed from the cut-out opening 14a.

In such a vehicle ceiling material 1, a bracket BK can be attached via a hot-melt adhesive to the fiber body layer 20 exposed from the cut-out opening 14a. Particularly, the bracket BK is provided on the fiber body layer 20. For this reason, a reactive hot-melt adhesive does not need to be used, and accordingly, the bracket BK does not need to be made of an ABS resin.

In addition, the second film layer 22 is provided on a front side (on a lower side) of the fiber body layer 20 as illustrated in FIG. 1. The second film layer 22 is provided so as to cover the cut-out opening 14a. Thus, a decline in a ventilation blocking function due to the cutting-out in the back surface layer 14 can be suppressed.

Here, in the vehicle ceiling material 1 according to the present embodiment, an area of the fiber body layer 20 and an area of the second film layer 22 are equal to each other as illustrated in FIG. 1 and FIG. 2, but particularly do not need to be equal to each other. Particularly, even when an area of the second film layer 22 is smaller than an area of the fiber body layer 20, the second film layer 22 may cover the cut-out opening 14a. An area of the second film layer 22 may be larger than an area of the fiber body layer 20.

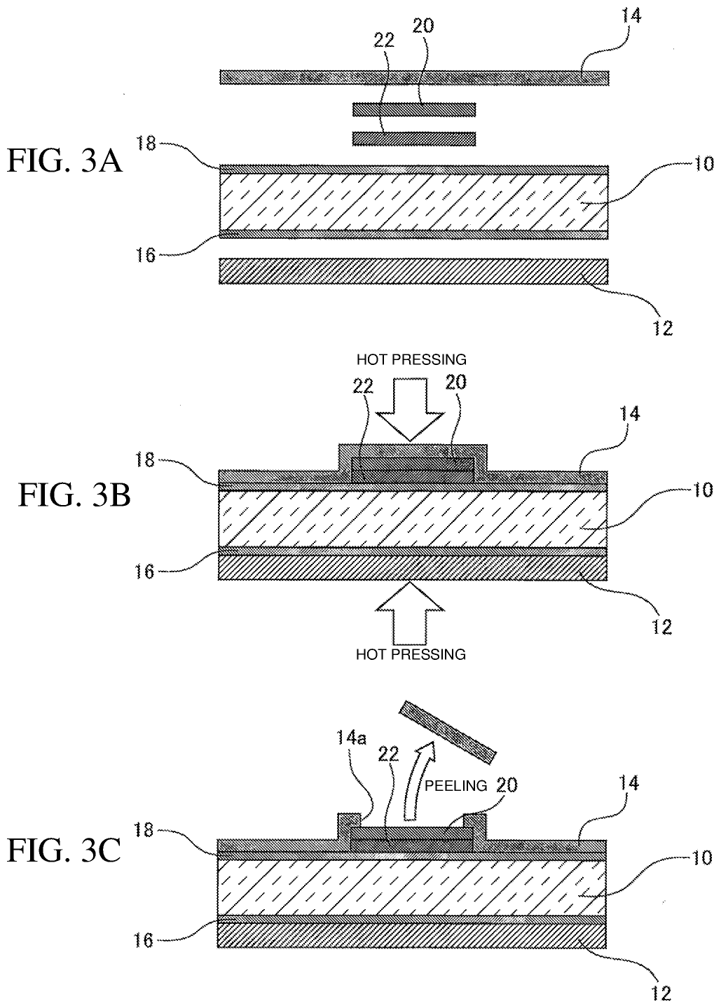

FIG. 3A to FIG. 3C are step diagrams illustrating a method for manufacturing the vehicle ceiling material 1 according to the present embodiment. FIG. 3A illustrates a layering step. FIG. 3B illustrates a hot pressing step. FIG. 3C illustrates a cutting-out step.

First, at the layering step, the skin layer 12 is layered on a front-surface side of the base material 10, and the back surface layer 14 is layered on a back-surface side of the base material 10, in a state where the first adhesive layer 16 and the second adhesive layer 18 are formed on the front and back surfaces of the base material 10, as illustrated in FIG. 3A. Further, the fiber body layer 20 and the second film layer 22 are interposed partially between the base material 10 and the back surface layer 14. Water containing amine diluted with it is applied to the front and back surfaces of the base material 10 by spraying or the like. Glass fibers coated or impregnated with isocyanate are provided to these water-application surfaces. Thereby, the first adhesive layer 16 and the second adhesive layer 18 are formed.

Next, at the hot pressing step (first step), the layered body that is layered as illustrated in FIG. 3A is hot-pressed as illustrated in FIG. 3B. At this step, the water applied to the front and back surfaces of the base material 10 evaporates, and the water vapor and the amine spread throughout the glass fibers coated or impregnated with the isocyanate. As a result, the isocyanate rapidly cures by the moisture, the amine, and the heat, thereby exhibiting an adhesion effect.

Next, at the cutting-out step (second step), a part of the back surface layer 14 in the pressed layered body made as illustrated in FIG. 3B is cut out by a laser or a cutting blade as illustrated in FIG. 3C. The part cut out at this time is a part included in the back surface layer 14 and positioned on the fiber body layer 20, and has an area smaller than an area of the fiber body layer 20.

As described above, it is possible to manufacture the vehicle ceiling material 1 that includes the back surface layer 14 constituted substantially entirely by the film layer and that however includes the fiber body layer 20 for the bracket attachment portion. Although the hot pressing step is performed in the above description as illustrated in FIG. 3B, there is no limitation to this. For example, the first and second adhesive layers 16 and 18 may be constituted simply by adhesives, and the respective layers may be stuck to these adhesives.

Thus, the vehicle ceiling material 1 according to the present embodiment includes the fiber body layer 20 between the back surface layer 14 and the second adhesive layer 18. The fiber body layer 20 is formed of a fiber, and is provided partially to the back surface layer 14. The part included in the back surface layer 14 and positioned over the fiber body layer 20 is cut out. Accordingly, even when the film layer is provided as the back surface layer 14, the fiber body layer 20 is exposed at the part. The bracket BK can be attached to this part by using an olefin-based hot-melt adhesive or the like, for example. Thus, when the film layer is provided as the back surface layer 14, an advantage is obtained in terms of cost, and the bracket BK can be satisfactorily attached without necessity of using a hot-melt adhesive that takes a great deal of time and work in terms of management.

The second film layer 22 having the ventilation blocking function is further provided. The second film layer 22 is provided so as to correspond to at least the part (cut-out opening 14a) cut out in the back surface layer 14. Thus, the second film layer 22 is provided at the cut-out part that is in the back surface layer 14 and at which the back surface layer 14 cannot block ventilation. Thereby, a decline in a ventilation blocking function due to the cutting-out in the back surface layer 14 can be suppressed.

Further, the method for manufacturing the vehicle ceiling material 1 according to the present embodiment includes the first and second steps. At the first step, the skin layer 12, the first adhesive layer 16, the base material 10, the second adhesive layer 18, and the back surface layer 14 are layered in this order and integrated with each other while the fiber body layer 20 is interposed between the back surface layer 14 and the second adhesive layer 18. The fiber body layer 20 is formed of a fiber, and is provided partially to the back surface layer 14. At the second step, the part that is included in the back surface layer 14 in the integrated body and that is positioned over the fiber body layer 20 is cut out. Thus, even in the case of including the film layer as the back surface layer 14, the vehicle ceiling material 1 can be made such that the fiber body layer 20 is exposed at the part. Therefore, it is possible to provide the vehicle ceiling material 1 advantageous in terms of cost and enabling the bracket BK to be attached satisfactorily to the vehicle ceiling material 1 without necessity of using a hot-melt adhesive that takes a great deal of time and work in terms of management, when the vehicle ceiling material 1 includes the film layer as the back surface layer 14.

The present invention is described above based on the embodiment, but is not limited to the above-described embodiment. The present invention may be modified within the scope not departing from the essence of the present invention, and may be combined with a publicly known or well-known technique if possible. For example, although the second film layer 22 is provided in consideration of ventilation blocking in the above-described embodiment, there is particularly no limitation to this, and the vehicle ceiling material 1 does not need to include the second film layer 22 in the case such as one where ventilation blocking is not sought.

Further, the case where the bracket BK is attached to the fiber body layer 20 is described above in the above-described embodiment. However, there is no limitation to this, and the bracket does not need to be attached on the fiber body layer 20. For example, when a member, such as a metal vapor-deposited film, including metal is used as the back surface layer 14, this member influences a reception sensitivity of an antenna in arrangement of the antenna on the back surface layer 14. In such a case, a part of the back surface layer 14 is cut out so that the antenna is arranged on the fiber body layer 20. Thereby, the influence to the reception sensitivity can be suppressed. When the influence to the reception sensitivity of the antenna is desired to be suppressed, the interface peeling does not need to be suppressed, and thus, a non-metal member such as thick paper or resin for example may be provided instead of the fiber body layer 20. When the non-metal member is used instead of the fiber body layer 20, this member itself preferably has a ventilation blocking function.

### REFERENCE SIGNS LIST

1: Vehicle ceiling material
10: Base material
12: Skin layer
14: Back surface layer
14a: Cut-out opening
16: First adhesive layer
18: Second adhesive layer
20: Fiber body layer
22: Second film layer
BK: Bracket

1. A vehicle ceiling material comprising:
a base material;
a skin layer provided on a vehicle-interior side of the base material and forming a ceiling surface in a vehicle interior;
a back surface layer that is a film layer provided on a back-surface side of the base material;
a first adhesive layer between the base material and the skin layer;
a second adhesive layer between the base material and the back surface layer; and
a fiber body layer formed of a fiber and provided, between the back surface layer and the second adhesive layer, partially to the back surface layer;
wherein a part included in the back surface layer and positioned over the fiber body layer is cut out.

2. The vehicle ceiling material according to claim 1, further comprising
a second film layer positioned between the fiber body layer and the second adhesive layer and having a ventilation blocking function,
wherein the second film layer is provided so as to correspond to the part where the back surface layer is cut out.

3. (canceled)
